(19) United States
(12) Patent Application Publication
(10) Pub. No.: US 2006/0291808 A1
(43) Pub. Date: Dec. 28, 2006

(54) Recording medium, method and apparatus of controlling data reproduce from recording medium

(76) Inventor: Kang Soo Seo, Gyeonggi-do (KR)

Correspondence Address: HARNESS, DICKEY & PIERCE, P.L.C., P.O. BOX 8910, RESTON, VA, 20195, US

(21) Appl. No.: 10/573,268

(22) PCT Filed: Oct. 25, 2004
(86) PCT No.: PCT/KR04/02710

§ 371 Date: Mar. 23, 2006

(30) Foreign Application Priority Data
Oct. 31, 2003 (KR) 10-2003-0076752

(51) Int. Cl. H04N 7/00

(52) U.S. Cl. 386/95

(57) ABSTRACT

A recording medium, method and apparatus of controlling data reproduce from recording medium are disclosed. In an optical recording and reproducing apparatus controlling display of an external input signal and an internal optical disc reproducing signal, when a plurality of active programs corresponding to each signal attribute is provided, and when a desired display mode is decided, a display control method within a recording medium reproducing device includes generating at least one control command (Call API) so as to execute a reproducing engine suitable for the decided display mode among the at least one reproducing engine, thereby enhancing mutual compatibility between a newly standardized high density optical disc (BD) and peripheral apparatuses and providing more efficient and convenient functions to users.

### TECHNICAL FIELD

The present invention relates to a recording medium, and more particularly, to a recording medium, method and apparatus of controlling data reproduce from recording medium. Although the present invention is suitable for displaying signals that are inputted from sources different from one another onto a single screen.

### BACKGROUND ART

Recently, digital technology has developed with the advent of an outstanding growth and development in the compression technology and transmission technology of digital information and the advent of digital broadcasting (hereinafter referred to as “DTV”), which applies such compression and transmission technologies. Furthermore, a new type of high density recording medium, such as the Blu-ray disc (hereinafter referred to as “BD”) for adopting high definition and large capacity digital broadcasting is also being under development. A global standard for the technical specification of the blu-ray disc (BD), which is a next generation high density recording medium technology, is being established along with the recent digital broadcasting technology. Herein, the blu-ray disc is considered to be a next generation optical recording solution that is capable of having data significantly surpassing the conventional DVD. Accordingly, optical recording and reproducing apparatuses adopting the blu-ray disc standard are also being manufactured and developed.

Most particularly, in the above-described optical recording and reproducing apparatus, the basic function(s) of reproducing the recording medium, as well as additional functions taking into account a combined usage with related peripheral digital apparatuses are/is being considered. Thus, generally, the optical recording and reproducing apparatus must be provided with functions of either receiving digital broadcast signals and displaying the received digital broadcast signals, or recording the digital signals within a built-in recording medium. However, in the blu-ray disc (BD) that is currently being proposed, a unified standard for achieving such functions are yet to be developed, thereby causing limitations in creating blu-ray disc (BD)-based optical recording and reproducing apparatuses. And, accordingly, there may lie problems in reproducing (or displaying) information onto a screen, wherein the information are inputted from an external source and reproduced from the built-in recording medium.

### DISCLOSURE OF INVENTION

An object of the present invention devised to solve the problem lies on providing a recording medium, method and apparatus of controlling data reproduce from recording medium that can substantially obviate one or more problems due to limitations and disadvantages of the related art.

Another object of the present invention devised to solve the problem lies on providing a recording medium, method and apparatus of controlling data reproduce from recording medium that can reproduce in combination external input data inputted to an optical recording and reproducing apparatus and internal recording medium data.

Another object of the present invention devised to solve the problem lies on providing a recording medium, method and apparatus of controlling data reproduce from recording medium that can provide a display control command, which is used in an optical recording and reproducing apparatus, as a set of standardized information, thereby providing mutual compatibility.

A further object of the present invention devised to solve the problem lies on providing a recording medium, method and apparatus of controlling data reproduce from recording medium that use a standardized display control command, thereby providing an efficient display.

The object of the present invention can be achieved by providing in reproducing a set of external input data and a set of internal recording medium data, a reproducing method of a recording medium reproducing device including steps of selecting at least one of the set of external input data and the set of internal recording medium data, executing at least one reproducing engine so as to reproduce the selected data in accordance with an attribute of the selected data, and displaying the data reproduced through the reproducing engine.

In another aspect of the present invention, provided herein is, in reproducing a set of external input data and a set of internal recording medium data, a reproducing method of a recording medium reproducing device including a selection unit selecting at least one set of the external input data and the internal recording medium data as input signal, at least one reproducing engine reproducing the selected data in accordance with an attribute of the selected data, and a controller transmitting a control command to the selection unit, so as to select the input signal, when a desired display mode is decided, and transmitting another control command so as to execute a reproducing engine suitable for the decided display mode among the at least one reproducing engine.

In another aspect of the present invention, provided herein is, in a method of controlling display of a set of external input data and a set of internal recording medium data, a display control method within a recording medium reproducing device including steps of providing a plurality of reproducing engines corresponding to each attribute of a set of data being reproduced, and when a desired display mode is decided, generating at least one control command (Call API) so as to execute a reproducing engine suitable for the decided display mode among the at least one reproducing engine.

In another aspect of the present invention, provided herein is, in a recording medium reproducing device provided with a plurality of reproducing engines corresponding to each attribute of a set of data being reproduced, so as to control display of the data being reproduced, a display control method within a recording medium reproducing device including steps of providing a user-selectable display mode, when the recording medium is loaded, and when executing a specific display mode in accordance with a user-selection, generating at least one control command (Call API) so as to execute a reproducing engine suitable for the user-selected display mode among the at least one reproducing engine.

In another aspect of the present invention, provided herein is, an a recording medium reproducing device provided with a plurality of reproducing engines corresponding to each attribute of a set of data being reproduced, so as to control display of the data being reproduced, a display control method within a recording medium reproducing device including steps of receiving a display mode change command during reproduction of the recording medium, and depending upon a newly desired display mode, generating at least one control command (Call API) so as to execute a reproducing engine suitable for the display mode change command among the at least one reproducing engine.

In a further aspect of the present invention, provided herein is, in a recording medium including an area for recording main data and an area for recording menu information corresponding to the main data, the recording medium including a display menu recorded in the menu information, so as to enable a user to select a display mode for a set of external input data and also for the main data recorded in the recording medium.

### BRIEF DESCRIPTION DRAWINGS

The accompanying drawings, which are included to provide a further understanding of the invention, illustrate embodiments of the invention and together with the description serve to explain the principle of the invention.

In the drawings:

FIG. 1 illustrates a general view of the present invention.

FIG. 2 illustrates a reproducing device in an optical recording and reproducing apparatus according to the present invention.

FIG. 3 illustrates an example of a reproducing method of display Mode A and reproducing device in the optical recording and reproducing apparatus according to the present invention.

FIG. 4 illustrates another example of a reproducing method of display Mode C and reproducing device in the optical recording and reproducing apparatus according to the present invention.

FIG. 5 illustrates a screen structure of display Mode B and possible display types in the optical recording and reproducing apparatus according to the present invention.

FIG. 6 illustrates a reproducing method and device of the display Mode B type (1) in the optical recording and reproducing apparatus according to the present invention.

FIG. 7 illustrates a reproducing method and device of the display Mode B type (2) in the optical recording and reproducing apparatus according to the present invention.

FIG. 8 illustrates a reproducing method and device of the display Mode B type (3) in the optical recording and reproducing apparatus according to the present invention.

FIG. 9 illustrates a reproducing method and device of the display Mode B type (4) in the optical recording and reproducing apparatus according to the present invention.

FIG. 10 illustrates a table showing examples of control commands (Call API) for controlling display in the optical recording and reproducing apparatus according to the present invention.

FIG. 11 illustrates an example of a structure of the recording medium according to the present invention and a menu screen recorded within the recording medium.

FIG. 12 illustrates a control process of a display mode selected from the menu screen in the optical recording and reproducing apparatus according to the present invention.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts. In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meaning of each term lying within.

In this detailed description, “recording medium” refers to all types of medium that can record or have already recorded data and broadly includes all types of medium regardless of the recording method, such as an optical disc, a magnetic tape, and so on. Hereinafter, for simplicity of the description of the present invention, the optical disc and, more specifically, the “read-only blu-ray disc (BD)” will be given as an example of the recording medium proposed herein. However, it will be apparent that the spirit or scope of the present invention may be equally applied to other types of recording medium.

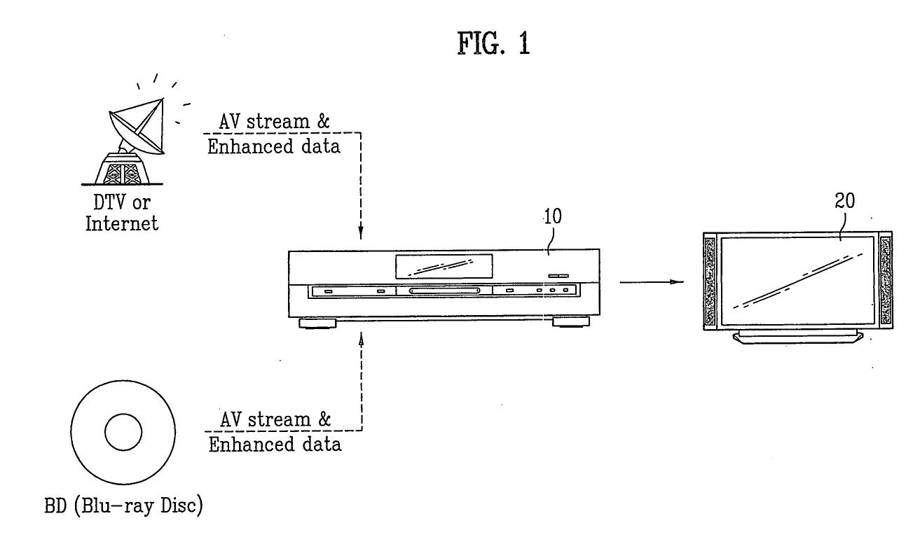

FIG. 1 illustrates a general view of the present invention, which shows an example of a combined usage between an optical recording and reproducing apparatus 10 and peripheral apparatuses. The optical recording and reproducing apparatus 10 according to the present invention is an apparatus for recording and reproducing optical discs of various standards (or sizes). The optical recording and reproducing apparatus 10 may also be designed to record and reproduce an optical disc of a specific standard (e.g., a blu-ray disc (BD)). Alternatively, the apparatus may also be designed to only have a reproducing function and no recording function. However, considering the completion of the blu-ray disc (BD) standard and its connection with the peripheral apparatuses, a BD-Player reproducing the read-only blu-ray disc (BD), which is recorded in accordance with the blu-ray disc (BD) format, will be used as an example in the description of the present invention. Accordingly, it is apparent that the optical recording and reproducing apparatus 10 according to the present invention may also be adopted in a “drive”, which can be mounted in computers.

Also, in the present invention, a “reproducing device of a recording medium” refers to a type of device that is provided in the optical recording and reproducing apparatus 10 and that performs a reproducing method according to the present invention. More specifically, apart from the function of recording and reproducing an optical disc, the optical recording and reproducing apparatus 10 according to the present invention also receives external signals, processes the received signals, and provides the processed signals to the users by transmitting the processed signals to a screen through another external display 20. In this case, there are no limitations in the external signals that can be inputted, wherein the external input signals mainly consist of digital broadcasting (DTV) signals, Internet signals, and so on. Most particularly, the DTV signals are high definition, high capacity signals corresponding to the blu-ray disc (BD), and the two media are co-dependent to one another. Therefore, the DTV signals are considered to be the most important external input signals. Hereinafter, the external input signal will be referred to as the DTV signal and internal playback signals will be referred to as the blu-ray disc (BD) reproduction (or playback) signal for simplicity. Furthermore, it is apparent that various modifications and variations can be made in the present invention without departing from the spirit or scope of the invention.

Each of the DTV signal and the blu-ray disc (BD) playback signal largely includes two types of data forms, which are an “AV stream” form and an “enhanced data” form. More specifically, the “AV stream” refers to audio/video (AV) contents providing audio and video data, such as movies (or motion pictures), and the “enhanced data” refers to data contents that transmit information. The “AV stream” of the DTV signal usually refers to moving image data transmitted from broadcast stations, and most particularly, to receiving data compressed to an MPEG-2 format, which is transmitted in the form of a signal through a specific transmission method (e.g., VSB, OFDM, etc.). Herein, the signal is received through a tuner (not shown) of the optical recording and reproducing apparatus 10, wherein the signal is processed, and then, the processed signal is provided to the user through a display 20. Evidently, the “AV stream” may also be directly received at the display 20 without having to pass through the optical recording and reproducing apparatus 10. However, since such instance does not lie within the scope of the present invention, detailed description of the same will be omitted.

Furthermore, the “enhanced data” of the DTV signal refers to a type of data broadcasting that includes information characteristic of digital broadcasting, and more specifically, all types of information that can be transmitted in the form of data, such as news information, stock information, sports relay through SMS, daily broadcast program information, and so on. Herein, the “enhanced data” of the DTV signal may be an additional (or auxiliary) data broadcast signal of the “AV stream” that is currently being broadcasted. Alternatively, the “enhanced data” of the DTV signal may also be a data broadcast signal that is irrelevant (or independent) from the “AV stream” that is currently being broadcasted.

In addition, the “AV stream” and “enhanced data” of the BD playback signal either refer to information that are created by recording the “AV stream” and “enhanced data” of the DTV signal within the BD and reproducing the recorded data, or refer to the “AV stream” and “enhanced data” differentiated and recorded accordingly by the BD manufacturer upon the fabrication of the read-only blu-ray disc (BD). Accordingly, the “enhanced data” may be recorded to provide additional information that improves the additional value of the “AV stream” in a graphic form. Alternatively, when the “enhanced data” is an application emphasizing reciprocal communication with the user, such as a game, the “enhanced data” is used and applied to ensure interactivity with the user. More specifically, the “XTML” and the “Java Program” are the most widely known technologies that can enable such interactivity.

Most particularly, the “enhanced data” from the Java program is reproduced by a Java Module, which is a reproducing engine that is only used for the Java Program. Herein, the Java Module is generally programmed to control the reproduction of AV streams. Therefore, depending upon a user-selection or depending upon pre-programmed enforced demands (or requests), such as in some particular cases, the optical recording and reproducing apparatus 10 selectively reproduces the AV stream and the enhanced data. Then, the reproduced data may be provided to a screen through the display 20.

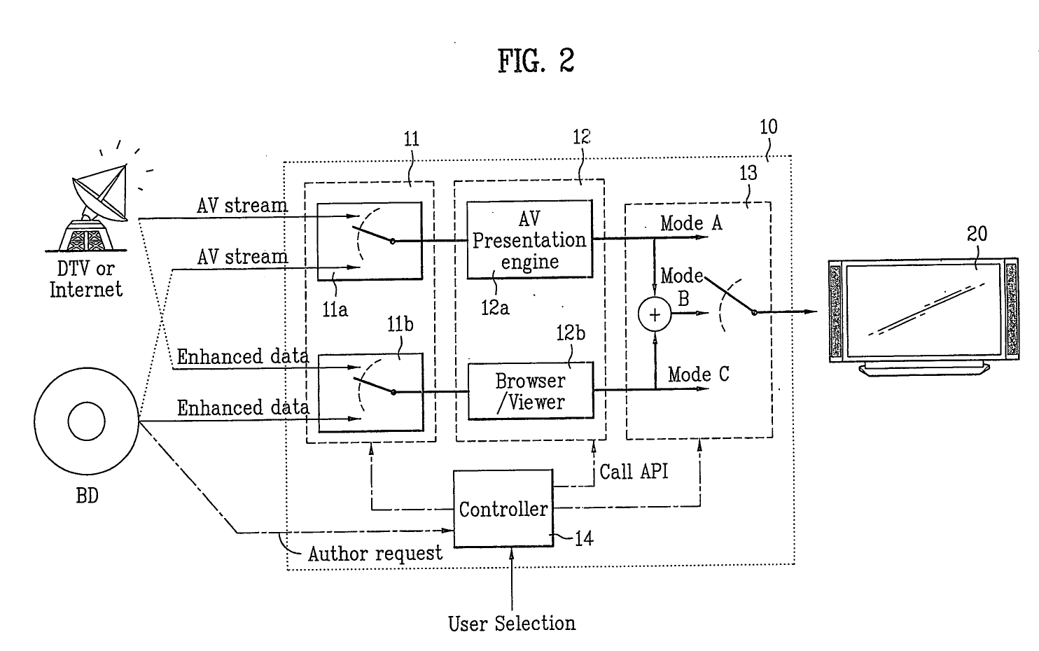

FIG. 2 illustrates a general view of a method for reproducing an input signal and a reproducing device in the optical recording and reproducing apparatus 10 according to the present invention. Referring to FIG. 2, the related art decoding process of processing signals and recovering the AV stream and the enhanced data will be omitted for simplicity of the description. However, the characteristics of the decoding process are clearly illustrated in the reproducing method and device according to the present invention.

When a user-selection command exists or when a BD disc manufacturer pre-programs and forcibly requests specific matters (hereinafter collectively referred to as an “Author request”), the optical recording and reproducing apparatus 10 according to the present invention decides a display mode (i.e., Mode A, Mode B, and Mode C) based upon such command or request. Then, a control command for selecting a specific signal among a plurality of input signals is transmitted to a selection unit 11. Further, the optical recording and reproducing apparatus 10 transmits the control command for executing an active program (also referred to as a “tool”), which displays the decided input signal, to a reproducing engine 12 to which a plurality of active programs is provided. Accordingly, each of the active programs (or tools) may become an individual reproducing engine for reproducing information of a specific attribute.

In addition, prior to finally transmitting signals to the display 20, the optical recording and reproducing apparatus 10 also transmits a control command to a display pre-processing unit 13 so as to pre-process signals. This process will now be described in more detail. The selection unit 11 selects a specific signal among a plurality of signals depending upon an input signal selection control command received from the controller. More specifically, the selection unit 11 includes a first selection means 11a selecting an AV stream from one of the DTV signal and the BD playback signal, and a second selection means 12a selecting a set of enhanced data from one of the DTV signal and the BD playback signal. However, in FIG. 2, each of the individual selection means 11a and 11b has been illustrated for simplicity of the description, and it is apparent that a single integrated selection unit 11 can be used in an actual application.

A plurality of active programs is provided to the reproducing engine 12, which executes specific active programs corresponding to specific signals depending upon the control command from the controller 14. More specifically, the control command that is transmitted from the controller 14 to the reproducing engine 12 is referred to as a “Call Application Protocol Interface (API)”. Herein, the Call API includes a series of command language designating a specific active program that is chosen to be executed among each of the active program (or tool) included therein. A detailed description of the command language will follow in a later process. Also, the reproducing engine 12 largely includes an AV presentation engine 12a and a browser/viewer 12b.

The AV presentation engine 12a is an active program (or tool) for displaying the AV stream, and the browser/viewer 12b is an active program (or tool) for displaying the enhanced data. In addition, the above-described Java module, which processes the enhanced data of the Java program, is also another type of reproducing engine. The terms used for the active programs according to the present invention will now be described in detail. The AV presentation engine 12a may be used as an active program for reproducing the AV stream and also as an AV player for reproducing moving images and sound. For example, the active programs include programs, such as the “Window_Media_Player” or the “Real_Player”, which are currently being widely used among general personal computers (PCs), and other active programs corresponding to such types of programs. Therefore, the AV presentation engine 12a may be programmed or named differently depending upon the standard applied to the signal that is to be actually executed.

The browser/viewer 12b is referred to as a “browser” when contents consisting of a mark-up language, such as HTML, are displayed. And, the browser/viewer 12b is referred to as a “viewer” or a “Java Module”, as described above, when enhanced contents such as Java programs are displayed. However, different terms may be used depending upon the usage environment or the user, and therefore, in the description of the present invention, the active program (or tool) executing the enhanced data, and not the AV stream, will be collectively referred to as the “browser”. In the present invention, active programs operating as software were given as examples of the reproducing engine 12. However, such active programs may also operate as hardware, the description of which is also included in the spirit and scope of the present invention.

The display pre-processing unit 13 processes signals prior to transmitting the display mode (i.e., Mode A, Mode B, and Mode C), which is decided from the controller 14, to the display. The display pre-processing unit 13 also adjusts the size of the display 20, the display position, and so on. More specifically, the present invention is designed to effectively reproduce input data of different attributes, and providing the reproduced data to a single screen in accordance with a selected display mode (i.e., Mode A, Mode B, and Mode C), which will now be described in detail. In other words, the display Mode A only displays the AV stream, wherein the display Mode A displays the AV stream onto the entire display 20 screen by using the reproduced (or played-back) signals, when no other specific command exists. Also, the display Mode C only displays the enhanced data, wherein the display Mode C displays the enhanced data onto the entire display 20 screen, when no other command exists. Finally, unlike the display Mode A and the display Mode C, the display Mode B displays the AV stream on a portion of the display 20 screen and displays the enhanced data on the remaining portion of the display 20 screen. Generally, the enhanced data is displayed as the background, and the AV stream is displayed through a window within the screen.

Referring back to FIG. 2, the basic operations of the present invention include deciding the display mode in accordance with a user command or an “Author request” recorded within the optical recording and reproducing apparatus 10, selecting an input signal for playback from the controller 14, executing a specific active program (or reproducing engine) in accordance with the attribute of the selected input signal, and finally, controlling a series of processes for adjusting the reproduced data so as to be suitably displayed on the screen. Accordingly, a “Call API” is commonly used as the control command for executing the specific active program, thereby facilitating the control of the active programs.

Moreover, the external input signal is downloaded from the optical recording and reproducing apparatus 10. And, in order to use such downloaded signal along with the optical disc within the apparatus, a storage means is required so as to store the external input signal within the optical recording and reproducing apparatus 10. Herein, the storage means is, more specifically, referred to as a local storage. Accordingly, when the local storage is not provided in the optical recording and reproducing apparatus 10, the external input signal may be reproduced (or played-back) without being stored separately. However, when the local storage is provided in the optical recording and reproducing apparatus 10, the reproducing method of the external input signal may become identical to the internal optical disc playback signal, or the external input signal and the internal optical disc playback signal may be reproduced (or played-back) in combination (or bound to one another). Therefore, it is preferable to the optical recording and reproducing apparatus 10 is equipped with the local storage.

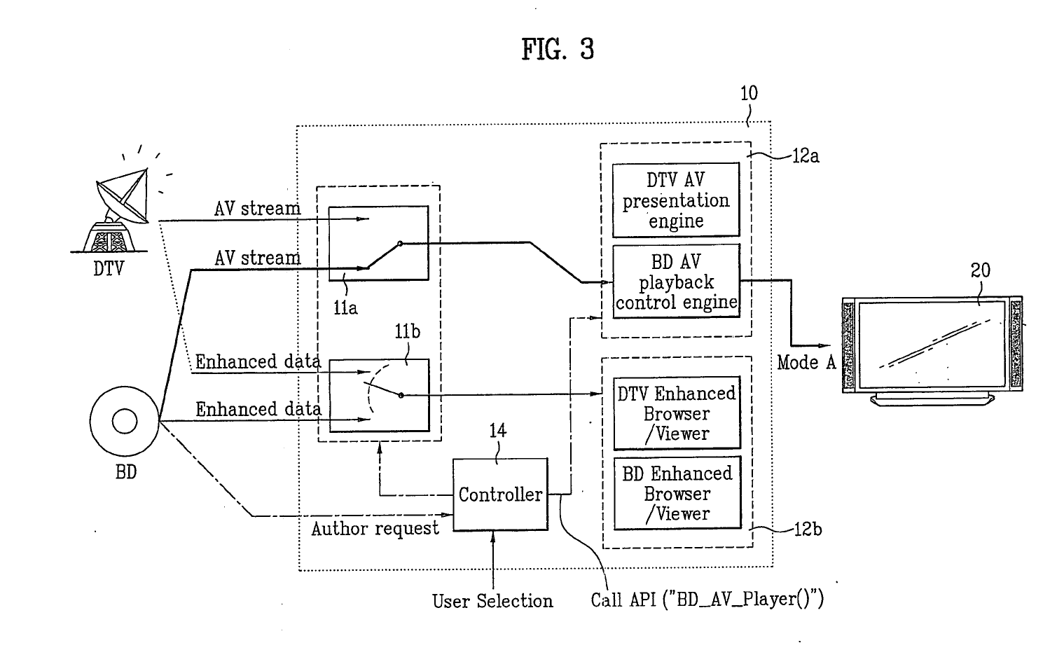

Hereinafter, the reproduction method and device for each of display Mode A, display Mode B, and display Mode C will now be described in detail with reference to FIGS. 3 to 10. FIG. 3 illustrates the reproduction method and device for the display Mode A according to the present invention. As described above, the display Mode A reproduces only the AV stream onto the screen, and FIG. 3 illustrates an example of the AV stream being displayed from the blu-ray disc (BD). The controller 14 selects the display Mode A, and when the input signal is decided as the BD playback signal, the selection means 11a is controlled to select and reproduce (or play-back) only the BD AV stream. Thereafter, a control command (Call API) “BD_AV_Player( )” is transmitted to the reproducing engine 12, thereby operating a tool for displaying the BD AV stream among the active programs provided in the reproducing engine 12. In this case, the active program (or tool) being operated is called a “BD AV Playback control engine”. Alternatively, when the display Mode A is decided, and when the input signal is decided as a DTV signal, a control command (Call API) “DTV_AV_Player( )” is transmitted to the reproducing engine 12, thereby operating a tool for displaying the DTV AV stream among the active programs provided in the reproducing engine 12. In this case, the active program (or tool) being operated is called a “DTV AV Presentation engine”.

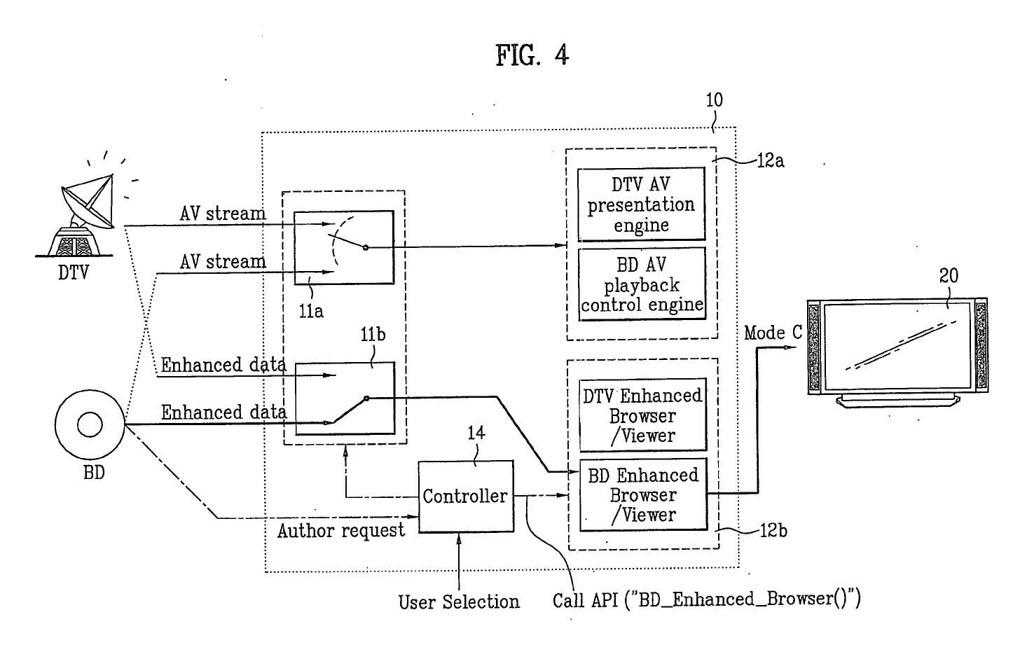

FIG. 4 illustrates the reproduction method and device for display Mode C according to the present invention. As described above, the display Mode C reproduces only the enhanced data onto the screen, and FIG. 4 illustrates an example of the enhanced data being displayed from the blu-ray disc (BD). The controller 14 selects the display Mode C, and when the input signal is decided as the BD playback signal, the selection means 11b is controlled to select and reproduce (or play-back) only the BD enhanced data. Thereafter, a control command (Call API) “BD_Enhanced_Browser( )” is transmitted to the reproducing engine 12, thereby operating a tool for displaying the BD enhanced data among the active programs provided in the reproducing engine 12. In this case, the active program (or tool) being operated is called a “BD Enhanced Browser/Viewer”. Alternatively, when the display Mode C is decided, and when the input signal is decided as a set of DTV enhanced data, a Call API “DTV_Enhanced_Browser( )” is, transmitted to the reproducing engine 12, thereby operating a tool for displaying the DTV enhanced data among the active programs provided in the reproducing engine 12. In this case, the active program (or tool) being operated is called a “DTV Enhanced Browser/Viewer”.

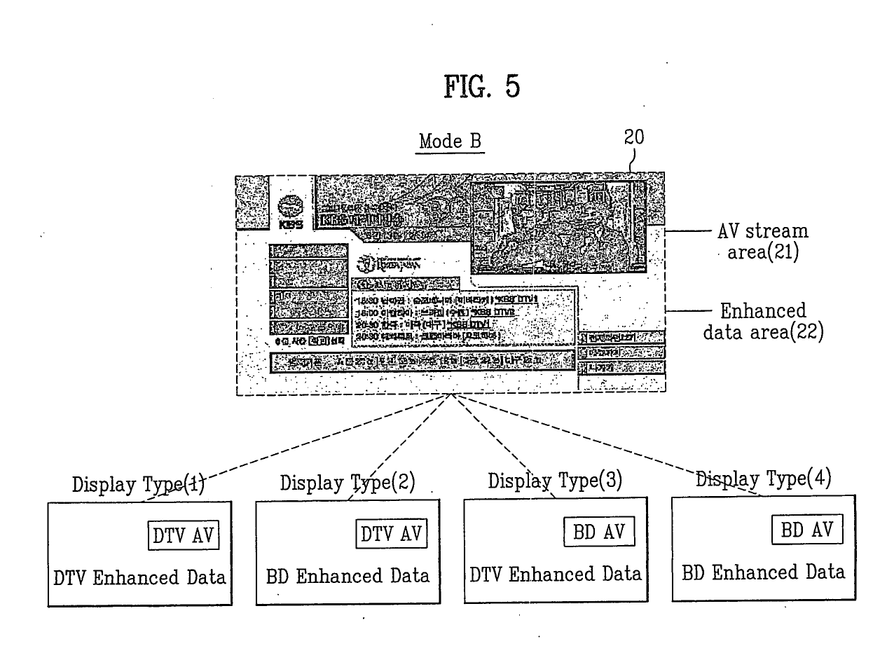

As described above, when a Java program provides the enhanced data, a “Java module” becomes the active program. FIGS. 3 and 4 are examples of displaying only one signal onto the final display 20, wherein the signal is one of the AV stream and the enhanced data, respectively. Accordingly, only one corresponding control command (Call API) exists herein. FIGS. 5 to 9 illustrate the reproduction method and device for display Mode B according to the present invention. In the display Mode B, different types of input signals are displayed onto a single display 20, and the input signals are then categorized into a plurality of display types, which will now be described in detail.

FIG. 5 illustrates an example of an actual display screen of display Mode B. Herein, the display 20 includes an AV stream display area 21 and an enhanced data display area 22. Generally, the enhanced data display area 22 is executed as a background picture of the entire display 20, and the AV stream display area 21 is represented as a window on one side of the display 20. However, such display screen is only an example of a wide range of display screens. For example, the AV stream display area 21 may be executed as the background picture of the entire display 20, and the enhanced data display area 22 may be represented as a window on one side of the display 20.

When representing the above-described display Mode B, a plurality of display screen is formed, wherein each of the display screens is different from one another depending upon the type of inputted signal. In the description of the present invention, each of the display screens will be referred to as a display type. Accordingly, each of the source of the AV stream signal and the source of the enhanced data signal respectively consists of a DTV signal and a BD playback signal. Thus, a total of four display types exist, which are referred to as display type (1), display type (2), display type (3), and display type (4). More specifically, in the display type (1), the source of both the AV stream and the enhanced data is the DTV signal. In the display type (2), the source of the AV stream is the DTV signal and the source of the enhanced data is the BD playback signal. In the display type (3), the source of the AV stream is the BD playback signal and the source of the enhanced data is the DTV signal. And, finally, in the display type (4), the source of both the AV stream and the enhanced data is the BD playback signal.

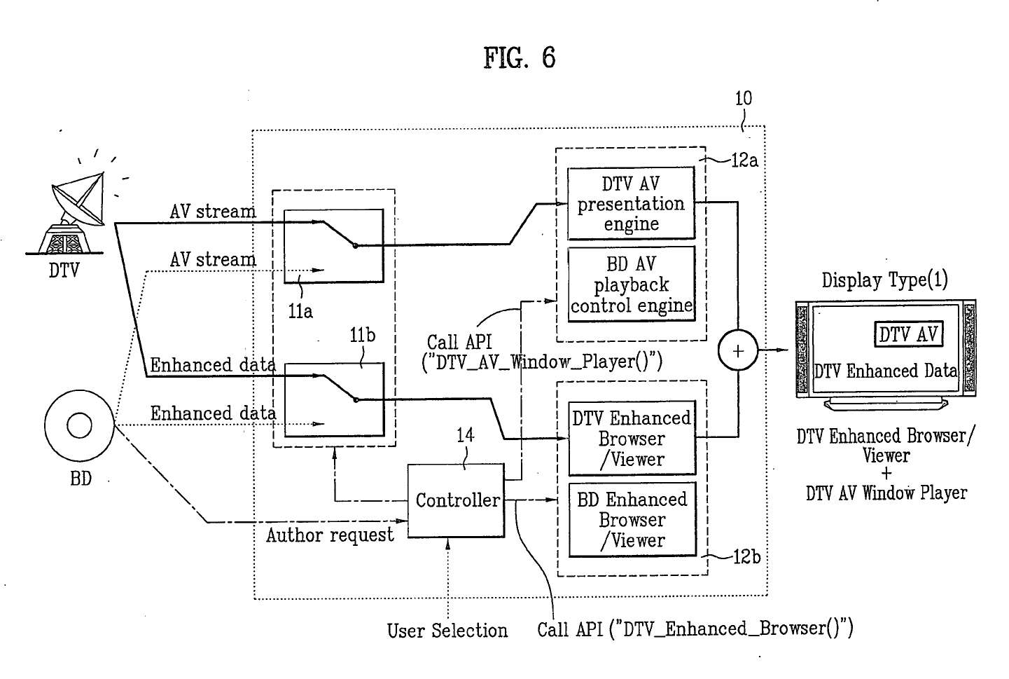

Hereinafter, a method and apparatus for controlling display for each display type will now be described in detail with reference to FIGS. 6 to 9. FIG. 6 illustrates a reproducing method and device of the display Mode B type (1) in the optical recording and reproducing apparatus according to the present invention. As described above, in the display type (1), the source of both the AV stream and the enhanced data is the DTV signal. Accordingly, each of the selection means 11a and 11b selects the corresponding input signal. Then, in accordance with the display type (1), the controller 14 transmits control commands (Call API), so as to execute the “DTV AV Presentation engine” in the AV presentation engine 12a and to execute the “DTV Enhanced Browser/Viewer” in the browser/viewer 12b, respectively. More specifically, since the AV stream is displayed as a window within the display 20, the Call APIs would be a “DTV_AV_Window_Player( )” and a “DTV_Enhanced_Browser ( )”. The reproducing engine 12 that receives the Call API executes the active program, which is designated by the Call API, thereby providing a picture suitable for a final display type (1).

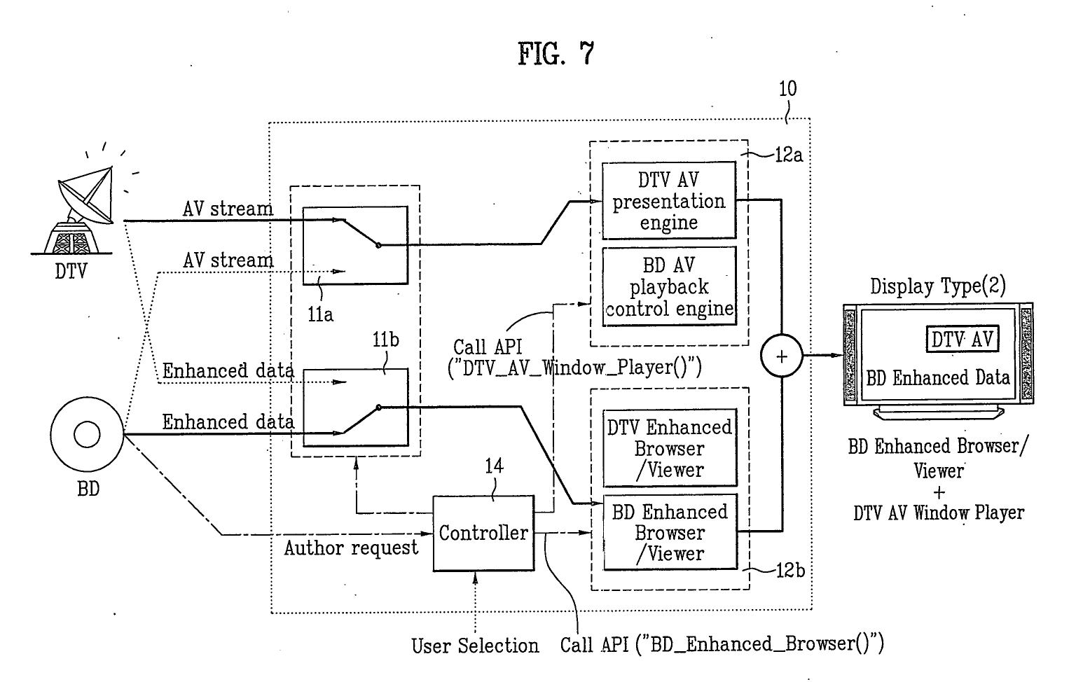

FIG. 7 illustrates a reproducing method and device of the display Mode B type (2) in the optical recording and reproducing apparatus according to the present invention. As described above, in the display type (2), the source of the AV stream is the DTV signal and the source of the enhanced data is the BD playback signal. Accordingly, each of the selection means 11a and 11b selects the corresponding input signal. Then, in accordance with the display type (2), the controller 14 transmits control commands (Call API), so as to execute the “DTV AV Presentation engine” in the AV presentation engine 12a and to execute the “BD Enhanced Browser/Viewer” in the browser/viewer 12b, respectively. More specifically, since the AV stream is displayed as a window within the display 20, the Call APIs would be a “DTV_AV_Window_Player( )” and a “BD_Enhanced_Browser( )”. The reproducing engine 12 that receives the Call API executes the active program, which is designated by the Call API, thereby providing a picture suitable for a final display type (2).

Most particularly, since the display type (2) is an applicable display type, the digital broadcast program producer may provide auxiliary additional information of the DTV AV stream in a BD-ROM as enhanced data. And, in this case, the user may reproduce the DTV AV stream and simultaneously reproduce the enhanced data within the BD playback signal that is associated with the AV stream being reproduced. Accordingly, the DTV AV stream and the enhanced data are displayed onto a single stream, thereby facilitating the viewing of the broadcast program.

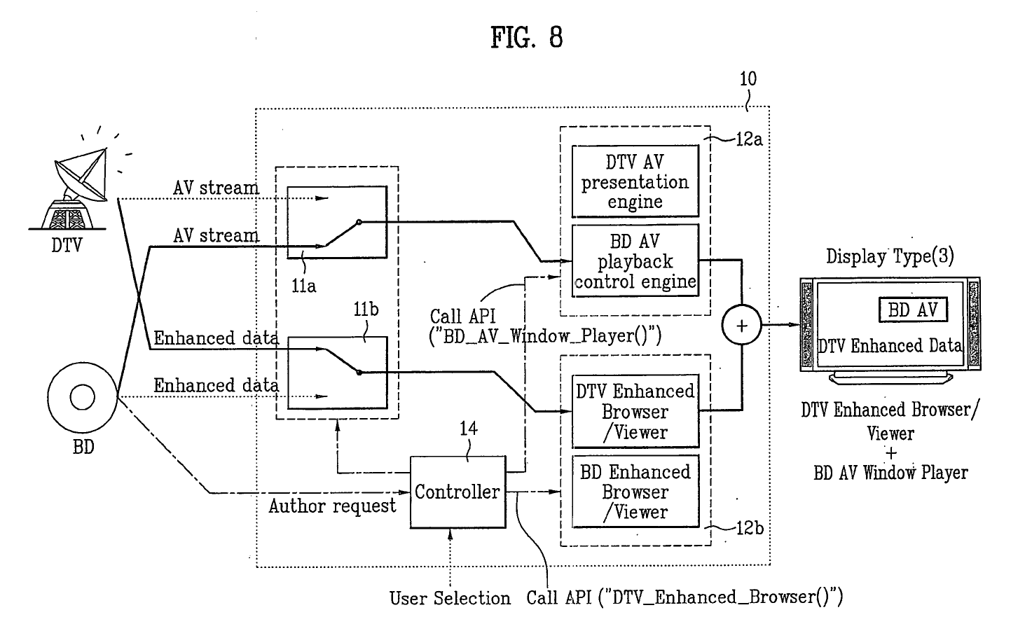

FIG. 8 illustrates a reproducing method and device of the display Mode B type (3) in the optical recording and reproducing apparatus according to the present invention. As described above, in the display type (3), the source of the AV stream is the BD playback signal and the source of the enhanced data is the DTV signal. Accordingly, each of the selection means 11a and 11b selects the corresponding input signal. Then, in accordance with the display type (3), the controller 14 transmits control commands (Call API), so as to execute the “BD AV Playback Control engine” in the AV presentation engine 12a and to execute the “DTV Enhanced Browser/Viewer” in the browser/viewer 12b, respectively. More specifically, since the AV stream is displayed as a window within the display 20, the Call APIs would be a “BD_AV_Window_Player( )” and a “DTV_Enhanced_Browser( )”. The reproducing engine 12 that receives the Call API executes the active program, which is designated by the Call API, thereby providing a picture suitable for a final display type (3).

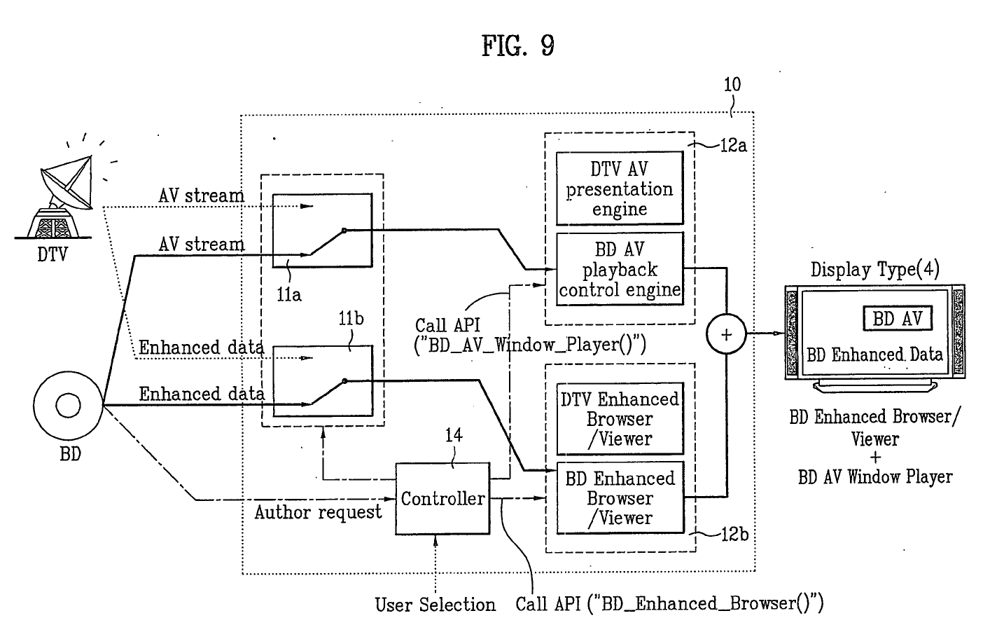

FIG. 9 illustrates a reproducing method and device of the display Mode B type (4) in the optical recording and reproducing apparatus according to the present invention. As described above, in the display type (4), the source of both the AV stream and the enhanced data is the BD playback signal. Accordingly, each of the selection means 11a and 11b selects the corresponding input signal. Then, in accordance with the display type (4), the controller 14 transmits control commands (Call API), so as to execute the “BD AV Playback Control engine” in the AV presentation engine 12a and to execute the “BD Enhanced Browser/Viewer” in the browser/viewer 12b, respectively. More specifically, since the AV stream is displayed as a window within the display 20, the Call APIs would be a “BD_AV_Window_Player( )” and a “BD_Enhanced_Browser( )”. The reproducing engine 12 that receives the Call API executes the active program, which is designated by the Call API, thereby providing a picture suitable for a final display type (4).

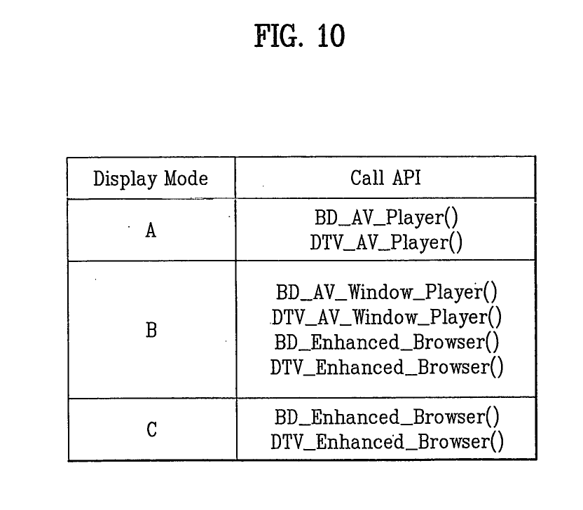

FIG. 10 illustrates a table showing the various types of Call APIs applicable to each of the display Mode A, display Mode B, and display Mode C, which are controlled according to the present invention. Detailed description of the types of Call APIs and the corresponding operations are given with reference to FIGS. 3 to 9, and henceforth, description of the same will be briefly mentioned. More specifically, in the example of the Call API given in FIG. 10, the external input signal is limited to a DTV signal for simplicity of the description. And, it is apparent that when the external input signal is changed to a different medium, the reference name of the medium will also be changed.

The Call API applicable to the display Mode A, which displays only the AV stream, may be one of “BD_AV_Player( )” and “DTV_AV_Player( )”. Alternatively, the Call API applicable to the display Mode C, which displays only the enhanced data, may be one of “BD_Enhanced_Browser ( )” and “DTV_Enhanced_Browser ( )”. And, finally, the Call API applicable to the display Mode B, which displays both the AV stream and the enhanced data, may be a combination of one of “BD_AV_Window_Player ( )” and “DTV_AV_Window_Player ( )” and one of “BD_Enhanced_Browser ( )” and “DTV_Enhanced_Browser ( )”. In the display Mode B, when the AV stream is displayed as a background picture and the enhanced data is displayed as a window, the Call API may additionally require “BD_Enhanced_Window_Browser ( )” and “DTV_Enhanced_Window_Browser ( )” but will not be illustrated in the drawing.

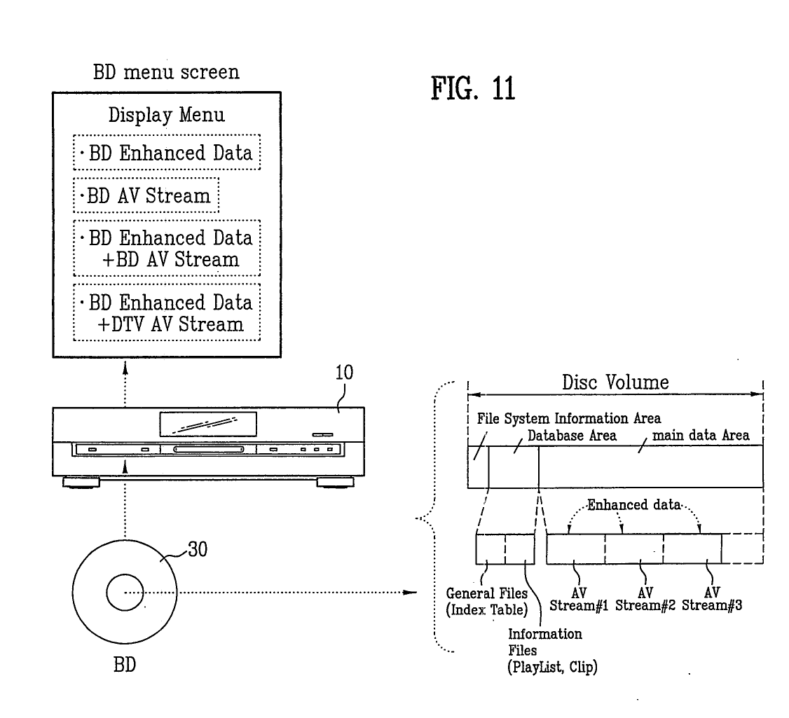

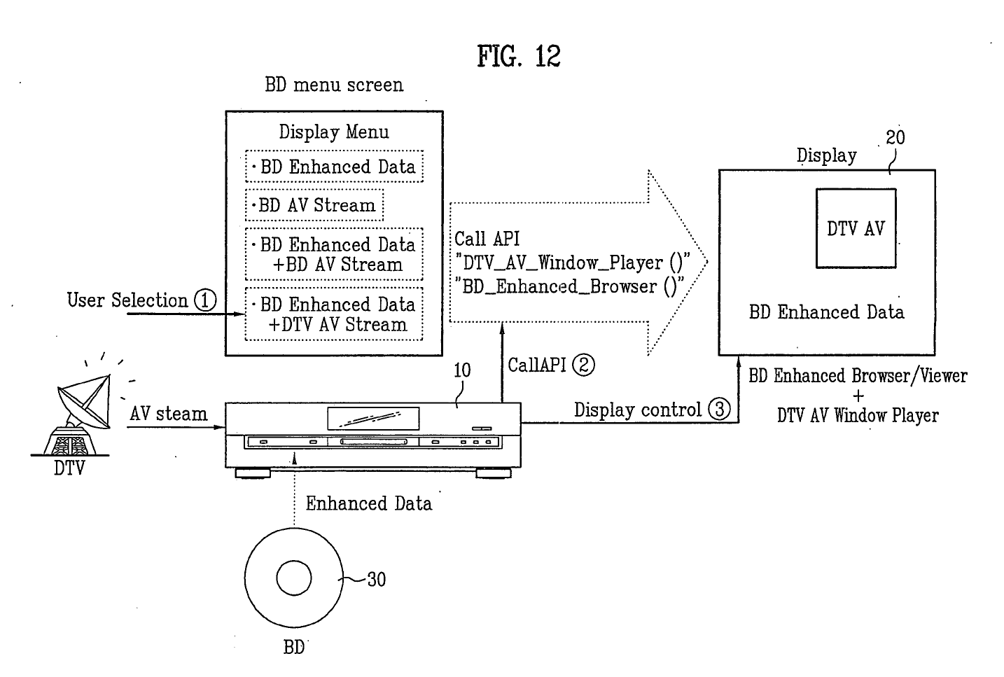

FIGS. 11 and 12 illustrate a method of using a set of menu information recorded within the optical disc, when controlling the display according to the present invention. FIG. 11 illustrates the structure of the read-only blu-ray disc (BD-ROM) 30 and also illustrates a display menu screen related to the present invention among the main menu screens provided to the user, when the BD-ROM is loaded in the optical recording and reproducing apparatus 10. The disc structure of the BD-ROM 30 will now be described in detail.

Starting from the inner circumference (or center) of the disc, the disc volume includes a file system information area, a database area, and a main data area. More specifically, the file system information area includes information on types and attributes of the files existing within the disc. The database area includes diverse application information for using the main data, and the main data area includes actual user information. Generally, AV streams are mainly recorded within the main data area, and enhanced data are included in combination within the beginning or mid-portion of the AV stream.

Also, an Index Table including user-selectable menu information is included as the application information recorded in the database area, and PlayList files and Clip files are included as files having reproduction control information for reproducing the main data. More specifically, when creating the Index Table, display menu information is also included in the present invention. Accordingly, other file information may also be recorded as the display menu information, instead of the Index Table, and such application is not limited to the present invention.

In other words, when the optical disc 30 is loaded, the optical recording and reproducing apparatus 10 creates a menu screen from the Index Table of the loaded optical disc. Herein, the display menu screen related to the present invention is included in the menu, and therefore, the user is able to select a desired display mode by using the menu screen. However, when using a specific type of disc, the display menu may be omitted, and the author may record in advance an enforced command for a specific display mode, which relates to the automatic selection of a display mode by an author request, shown in FIG. 2.

In continuation from the description of FIG. 11, FIG. 12 illustrates an example of selecting a specific display mode, which is desired by the user, from the display menu screen and also illustrates the display control operation after the selection of the display mode. When the user selects “BD Enhanced Data+DTV AV stream” (i.e., Mode B Type (2)) as the display mode (user-selection \textcircled{1}), the controller 14 of the optical recording and reproducing apparatus 10 generates a control command (Call API), i.e., control API \textcircled{2}, and the call API consists of DTV_AV_Window_Player( ) and BD_Enhanced_Browser depending upon the display mode selected by the user. The active program is operated in accordance with the control command (Call API). Then, the display is controlled so that a user-selected display mode is created on the final display 20 through the display pre-processing unit 13 within the optical recording and reproducing apparatus 10 (Display control \textcircled{3}.

In addition, even when the display mode is decided by the initial selection of the user, the display mode may be changed to another display mode during reproduction. And, the display mode may be changed by generating a new control command (Call API). More specifically, when the user wishes to change the display mode from display Mode B, whereby all of the AV stream and enhanced data are displayed, to display Mode A, whereby only the AV streams are displayed, the controller 14 generates a new control command, such as BD_AV_Player( ) or DTV_AV_Player( ), so as to change the display mode into a display mode for displaying only the AV streams.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention provides a control method and reproducing apparatus for controlling reproduction of an external input signal including mass amount high density recording medium reproducing signals and digital broadcast signals within the optical recording and reproducing apparatus. And, the present invention is advantageous in that mutual application between newly developed high density recording medium (e.g., BD-ROM) and peripheral apparatuses can be enhanced, and that effective and convenient functions can be provided to the users.

What is claimed is:

1. In reproducing a set of external input data and a set of internal recording medium data, a reproducing method of a recording medium reproducing device, comprising:
selecting at least one of the set of external input data and the set of internal recording medium data;
executing at least one reproducing engine so as to reproduce the selected data in accordance with an attribute of the selected data; and
displaying the data reproduced through the reproducing engine.

2. The method of claim 1, wherein each of the external input data and the internal recording medium data comprises at least one set of AV stream and one set of enhanced data.

3. The method of claim 2, wherein the reproducing engine includes a reproducing engine for AV streams and a reproducing engine for enhanced data.

4. The method of claim 2, wherein the enhanced data is provided as a Java program.

5. The method of claim 2, wherein the reproducing engine reproducing the enhanced data, which is provided as a Java program, is a Java module.

6. The method of claim 4, wherein the Java program is able to control AV stream reproduction.

7. The method of claim 1, wherein the external input data is a digital broadcast signal, and the internal recording medium data is a signal reproduced from a read-only blu-ray disc (BD-ROM).

8. The method of claim 1, wherein a control command (Call API) for executing each of the at least one reproducing engine is included separately.

9. The method of claim 1, wherein the reproducing engine is represented as a software.

10. The method of claim 1, wherein the reproducing engine is represented as a hardware.

11. The method of claim 3, wherein the reproducing engine includes an AV player for executing the AV stream, and a browser for executing the enhanced data.

12. The method of claim 11, wherein each of the AV player and the browser separately includes an AV player for digital broadcasting, an AV player for reproducing an internal recording medium, a browser for digital broadcasting, and a browser for reproducing an internal recording medium, respectively.

13. The method of claim 12, wherein a control command (Call API) controls each of the at least one reproducing engine, and wherein the reproducing engine executed by the control command (Call API) includes the AV player for digital broadcasting and the browser for reproducing the internal recording medium.

14. The method of claim 13, wherein the enhanced data that is reproduced from the browser for reproducing the internal recording medium is auxiliary to the AV stream that is reproduced from the AV player for digital broadcasting.

15. The method of claim 14, wherein the enhanced data being reproduced from the browser for reproducing the internal recording medium is provided by an author of the digital broadcasting.

16. The method of claim 12, wherein at least one control command (Call API) is separately included so as to execute each of the at least one reproducing engine, and wherein the at least one reproducing engine executed by the corresponding control command (Call API) includes the AV player for reproducing the internal recording medium and the browser for digital broadcasting.

17. The method of claim 12, wherein at least one control command (Call API) is separately included so as to execute each of the at least one reproducing engine, and wherein the at least one reproducing engine executed by the corresponding control command (Call API) includes the AV player for reproducing the internal recording medium and the browser for reproducing the internal recording medium.

18. The method of claim 12, wherein at least one control command (Call API) is separately included so as to execute each of the at least one reproducing engine, and wherein the at least one reproducing engine executed by the corresponding control command (Call API) includes the AV player for digital broadcasting and the browser for digital broadcasting.

19. In reproducing a set of external input data and a set of internal recording medium data, a reproducing method of a recording medium reproducing device, comprising:
a selection unit selecting at least one set of the external input data and the internal recording medium data as input signal;
at least one reproducing engine reproducing the selected data in accordance with an attribute of the selected data; and
a controller transmitting a control command to the selection unit, so as to select the input signal, when a desired display mode is decided, and transmitting another control command so as to execute a reproducing engine suitable for the decided display mode among the at least one reproducing engine.

20. In a method of controlling display of a set of external input data and a set of internal recording medium data, a display control method within a recording medium reproducing device comprising:
providing a plurality of reproducing engines corresponding to each attribute of a set of data being reproduced; and
when a desired display mode is decided, generating at least one control command (Call API) so as to execute a reproducing engine suitable for the decided display mode among the at least one reproducing engine.

21. In a recording medium reproducing device provided with a plurality of reproducing engines corresponding to each attribute of a set of data being reproduced, so as to control display of the data being reproduced, a display control method within a recording medium reproducing device comprising:
providing a user-selectable display mode, when the recording medium is loaded; and
when executing a specific display mode in accordance with a user-selection, generating at least one control command (Call API) so as to execute a reproducing engine suitable for the user-selected display mode among the at least one reproducing engine.

22. In a recording medium reproducing device provided with a plurality of reproducing engines corresponding to each attribute of a set of data being reproduced, so as to control display of the data being reproduced, a display control method within a recording medium reproducing device comprising:
receiving a display mode change command during reproduction of the recording medium; and
depending upon a newly desired display mode, generating at least one control command (Call API) so as to execute a reproducing engine suitable for the display mode change command among the at least one reproducing engine.

23. In a recording medium including an area for recording main data and an area for recording menu information corresponding to the main data, the recording medium comprising:
a display menu recorded in the menu information, so as to enable a user to select a display mode for a set of external input data and also for the main data recorded in the recording medium.

24. The recording medium of claim 23, wherein the display menu comprises a display mode for displaying a set of enhanced data within the recording medium and an AV stream within the external input signal in combination.

25. The recording medium of claim 23, wherein the recording medium is a read-only blu-ray disc (BD-ROM).
